(19) United States
(12) Patent Application Publication
(10) Pub. No.: US 2026/0369467 A1
(43) Pub. Date: Nov. 19, 2026

(54) TRANSFORMER AND METHOD FOR MOUNTING TRANSFORMER TO POWER SUPPLY SYSTEM

(71) Applicant: Hitachi Energy Ltd, Zürich (CH)

(72) Inventors: Weichi Zhang, Beijing (CN); XiaoBo Yang, Beijing (CN); HongXin Jin, Shanghai (CN); Jan Svensson, Västerås (SE); Nicklas Johansson, Västerås (SE)

(21) Appl. No.: 19/143,772

(22) PCT Filed: Mar. 30, 2023
(86) PCT No.: PCT/EP2023/058339

§ 371 Date: Jun. 26, 2025

(30) Foreign Application Priority Data
Dec. 28, 2022 (CN) 202211695640.X

(51) Int. Cl. H01F 29/02

(52) U.S. Cl. CPC H01F 29/02

(57) ABSTRACT

A transformer includes one or more primary windings configured to be coupled with an AC source. The transformer further includes at least two sets of secondary windings. Each set of secondary windings includes a high-power secondary winding configured to transfer high power to a load and a low-power secondary winding configured to transfer low power to the load. The high-power secondary winding and the low-power secondary winding of each set are configured to produce no difference in phase angle with respect to each other. A secondary winding of one set of the at least two sets and a secondary winding of the other set of the at least two sets are configured to produce a difference in phase angle with respect to each other.

### CROSS REFERENCE TO RELATED APPLICATIONS

This application is a 35 U.S.C. § 371 national stage application of PCT International Application No. PCT/EP2023/058339 filed on Mar. 30, 2023, which in turn claims foreign priority to Chinese Patent Application No. 202211695640.X, filed on Dec. 28, 2022, the disclosures and content of which are incorporated by reference herein in their entirety.

### TECHNICAL FIELD

The present disclosure relates to a transformer and a method for mounting the transformer to a power supply system.

### BACKGROUND

A transformer is a passive component that transfers electrical energy from one circuit to another circuit, or multiple circuits. In the prior art, researches have been carried out to improve various properties of transformers. However, when a transformer is disposed in a power supply system to power a load, either harmonic performance or energy efficiency of the system are not good enough.

Rautela Pradeep et al. describe “Design Consideration of High Power High Current Twelve Pulse Thyristor Controlled Rectifiers” in 2018 2nd International Conference on Power, Energy and Environment: Towards Smart Technology, IEEE, 1 Jun. 2018.

Bintz Steffen et al. describe “Parallel Rectifier for Regenerative Hydrogen Production Utilizing a Combination of Thyristor and PWM-based Topologies” in 2018 18th European Conference on Power Electronics and Applications, EPE Association, 17 Sep. 2018.

### SUMMARY

The invention is defined by the features of the independent claims.

According to an embodiment of the disclosure, a transformer is provided. The transformer includes one or more primary windings configured to be coupled with an AC source. The transformer further includes at least two sets of secondary windings. Each set of secondary windings comprising a high-power secondary winding configured to transfer high power to a load and a low-power secondary winding configured to transfer low power to the load. The high-power secondary winding and the low-power secondary winding of each set are configured to produce no difference in phase angle with respect to each other. The secondary windings in one set of the at least two sets and the secondary windings in the other set of the at least two sets are configured to produce a difference in phase angle with respect to each other.

According to another embodiment of the disclosure, a method for mounting a transformer as set forth to a power supply system for powering a load is provide. The power supply system includes an AC source and at least two converter modules. The method includes the following steps: coupling one or more primary windings of the transformer to the AC source, and coupling at least two sets of secondary windings of the transformer to the at least two converter modules, a high-power and a low-power secondary winding of each set of secondary windings being configured to transfer high power and low power to the load respectively. The high-power secondary winding and the low-power secondary winding of each set are configured to produce no difference in phase angle with respect to each other. The secondary windings in one set of the at least two sets and the secondary windings in the other set of the at least two sets are configured to produce a difference in phase angle with respect to each other.

### BRIEF DESCRIPTION OF THE DRAWINGS

The disclosed aspects will hereinafter be described in connection with the appended drawings that are provided to illustrate but not to limit the scope of the disclosure.

FIG. 1 is a block diagram of an exemplary system according to an example of the present disclosure.

FIGS. 2 and 3 are block diagrams showing a converter module according to examples of the present disclosure.

FIG. 4 shows an exemplary circuit of the converter module illustrated in FIG. 3.

FIGS. 5 and 6 are block diagrams showing a modular converter according to examples of the present disclosure.

FIGS. 7 and 8 show implementations of connecting a modular converter to a load according to examples of the present disclosure.

FIG. 9 is a flowchart of a method for controlling a modular converter to power to a load according to an example of the present disclosure.

FIGS. 10-14 are flowcharts showing examples of the main step of the method illustrated in FIG. 9.

FIGS. 15-18 are schematic diagrams showing exemplary structures of a transformer according to examples of the present disclosure.

### DETAILED DESCRIPTION

### Overview

Embodiments of the present disclosure relate to a solution for powering a DC load. Advantages of such a solution include high system efficiency, low device cost and small size.

According to an example of the present disclosure, the DC load (hereinafter, sometimes simply referred to as “load”) is powered by a power supply system including a modular multi-pulse converter and a phase shifting transformer (hereinafter, sometimes simply referred to as “transformer”) coupled with the modular multi-pulse converter. The modular multi-pulse converter includes at least two converter modules. The phase shifting transformer includes at least two sets of secondary windings coupled with the at least two converter modules. Each converter module includes two converters, wherein one converter is configured to transfer a majority of the total power to the DC load and the other converter can be controlled to process only a portion of the total power, i.e., the other converter is implemented as a partial power process converter. Controlling the partial power processing converter enables power supplied to the load to be controlled.

According to an example of the present disclosure, a controllable power supply to the load can be realized and thus the requirement for a customized power supply to the load can be satisfied. Moreover, the operating efficiency of the load can be improved.

According an example of the present disclosure, the powering solution is especially suitable for powering an electrolyzer because both the hydrogen production rate and the operating efficiency of the electrolyzer can be optimized based on the state of the electrolyzer. According to another example of the present disclosure, the powering solution is also suitable for providing an adjustable high voltage to a front end of a high-voltage rectification system. According to yet another example of the present disclosure, the powering solution is also suitable for providing a constant-current power supply or a constant-voltage power supply to the load.

According to an example of the present disclosure, the DC-DC topology can be implemented by using a step-up topology, and can also be implemented by using a step-down topology. Thus, examples of the present disclosure can be extensively applied to various application scenarios.

According to an example of the present disclosure, multiple converter modules can be configured to be connected in parallel or in series, and can power multiple loads simultaneously with a parallel configuration or a serious configuration. Thus, examples of the present disclosure can be extensively applied to various application scenarios.

According to an example of the present disclosure, each set of secondary windings of the phase shifting transformer includes a high-power secondary winding and a low-power secondary winding. This works in conjunction with the above-mentioned converter module including a partial power processing converter so that the majority of the total power is transferred through the high-power secondary winding and only a portion of the total power is transferred through the low-power winding.

According to an example of the present disclosure, the phase-shifting transformer is designed in consideration of the harmonic performance and fault condition of the power supply system, which makes such a phase shifting transformer a “tailor-made” transformer for powering the load.

In addition, according to an example of the present disclosure, an ecosystem including a power grid as well as the transformer, the modular converter and the load can be controlled cooperatively, so that the energy efficiency of the whole system can be optimized.

### Example Systems

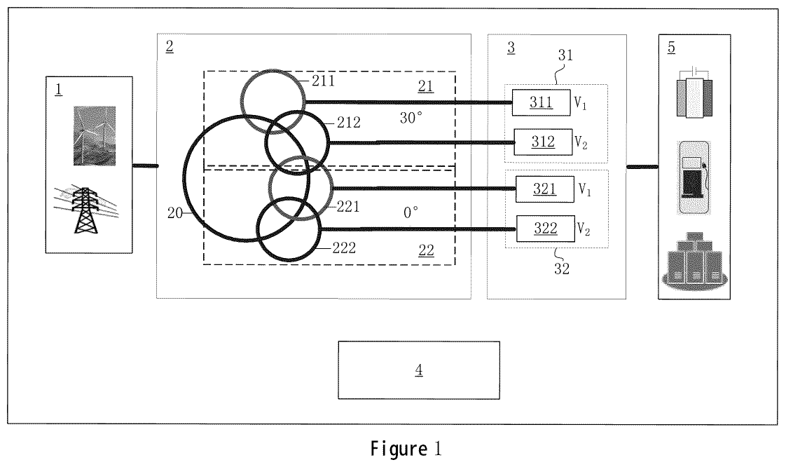

FIG. 1 schematically illustrates an exemplary system according to an embodiment of the present disclosure. As shown in FIG. 1, the exemplary system includes an AC source 1, a transformer 2, a modular converter 3, a controller 4 and a DC load 5.

The AC source 1 can be implemented as an AC grid (e.g., a grid-connection from AC transmission or off-grid from renewables) or coupled within a micro-grid. The AC source 1 can also be implemented as a PCC (point of common coupling) of a power

### System.

The transformer 2 is coupled between the AC source 1 and the modular converter 3 for transferring power between the AC source 1 and the modular converter 3. The transformer 2 includes at least one primary winding 20 and at least two sets of secondary windings, for example, a first set 21 and a second set 22. As shown in FIG. 1, the first set 21 of secondary windings includes a high-power secondary winding 211 and a low-power secondary winding 212. The second set 22 of secondary windings includes a high-power secondary winding 221 and a low-power secondary winding 222. Here, the high-power secondary winding can also be called a first power secondary winding, the low-power secondary winding can also be called a second power secondary winding, and the first power is greater than the second power.

For each set of secondary windings, the transformer 3 has a first turns-ratio between the primary winding and the first secondary winding and a second turns-ratio between the primary winding and the second secondary winding, so that the power transferred by the first secondary winding is higher than that transferred by the second secondary winding. That is to say, the first secondary winding transfers high power (i.e., first power), and the second secondary winding transfers low power (i.e., second power).

Among secondary windings, phase angles of two secondary windings of the same set are equal to each other, and phase angles of two secondary windings of different sets are phase shifted relative to each other. That is to say, the high-power secondary winding and the low-power secondary winding of the same set have the same phase angle. For example, both the high-power secondary winding and the low-power secondary winding of each set have a phase angle that is phase shifted relative to a reference phase (e.g., a virtual phase or a zero phase) by the same angle. Moreover, secondary windings have inter-set phase shift. In this way, a secondary winding in one secondary set is phase shifted relative to a secondary winding in another secondary set. For example, both the high-power secondary winding 211 and the low-power secondary winding 212 of the first set 21 have a first phase angle. Both the high-power secondary winding 221 and the low-power secondary winding 222 of the second set 22 have a second phase angle. The first phase angle is different than the second phase angle.

The modular converter 3 includes at least two converter modules, for example, a first converter module 31 and a second converter module 32. Each converter module includes two converters each outputs a DC voltage. At least one of two converters of each converter module can be controlled to output an adjustable DC voltage, thereby the powering of the load 5 is controllable. As shown in FIG. 1, the first converter module 31 includes a first converter 311 and a second converter 312. The second converter module 32 incudes a first converter 321 and a second converter 322. Each converter is configured to be coupled with a secondary wingding. For example, the first converter 311 and the second converter 312 of the first converter module 31 are configured to be coupled with the high-pow secondary winding 211 and the low-power secondary winding 212 of the first secondary set 21 respectively. The first converter 321 and the second converter 322 of the second converter module 32 are configured to be coupled with the high-pow secondary winding 221 and the low-power secondary winding 222 of the second secondary set 22 respectively.

For each converter module, the first converter coupled with the high-power secondary winding is configured to transfer the majority of the total power to the load, and the second converter (i.e., the partial power processing converter) coupled with the low-power secondary winding is configured to only process a portion of the total power. Taking the first converter module 31 as an example, the majority of the total power is transferred to the load 5 via the first converter 311, and the second converter 312 only process a partial of the total power.

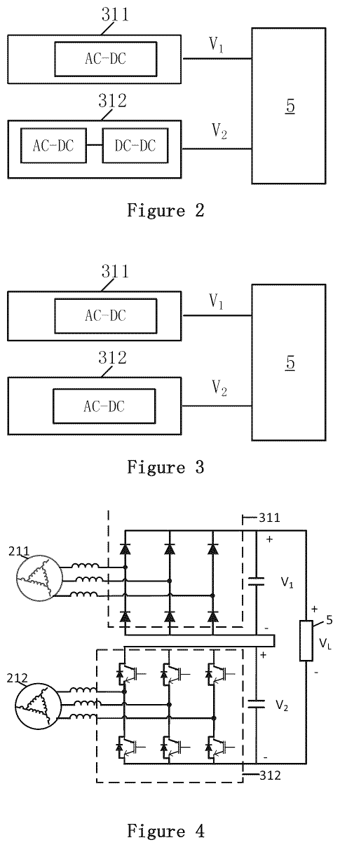

Next, taking the first converter module 31 as an example, the implementation of the converter module is introduced with reference to FIGS. 2 and 3.

Referring to FIG. 2, in an example, the first converter 311 is implemented as an AC-DC converter and outputs a first DC voltage V₁. The AC-DC converter can be implemented as a diode to output a fixed DC voltage. The AC-DC converter can also be implemented as a thyristor (i.e., a half-controlled device) to output an adjustable DC voltage. The second converter 312 can be implemented as an AC-DC converter and a DC-DC converter connected in series, and outputs a second DC voltage V₂ that is an adjustable DC voltage. Referring to FIG. 3, the second converter 312 can also be implemented as a single stage AC-DC converter and output a second DC voltage V₂ that is an adjustable DC voltage.

In addition, each converter module can be implemented as a step-up topology or a step-down topology. Taking the first converter module in FIG. 2 as an example, in the step-up topology, the voltage provided to the load 5 by the first converter module is equal to the sum of the first DC voltage V₁ output from the first converter 311 and the second DC voltage V₂ output from the second converter 312. In the step-down topology, the voltage provided to the load 5 by the first converter module is equal to the difference between the first DC voltage V₁ output from the first converter 311 and the second DC voltage V₂ output from the second converter 312.

FIG. 4 shows an implementation of the converter module shown in FIG. 3. For clarity, the converter module 31 is taken as an example for illustration.

Referring to FIG. 4, the first converter 311 connected to the high-power secondary winding 211 is a three-phase rectifier and is realized by three bridge arms composed of six diodes. The input of the first converter 311 is the three-phase AC current transferred by the high-power secondary winding 211. The second converter 312 connected to the low-power secondary winding 212 is realized as a three-phase fully-controlled rectifier and includes a plurality of switching devices. The plurality of switching devices can be realized, for example, by means of power electronic switches such as MOSFETs or IGBTs. Each switching device has a control terminal for receiving a control signal from the controller 4 so that the output of the second converter 312 is controllable.

Returning to FIG. 1, the load 5 is, for example, an electrolyzer for hydrogen production, a power battery of an electric vehicle, or a load of a data center.

With continuing reference to FIG. 1, the controller 4 is in communication with the transformer 2, the modular converter 3 and the load 5, and can exchange information with them. The controller 4 controls power supply to the load 5 based on feedback information from at least one of the transformer 2, the modular converter 3 and the load 5. In addition, the controller 4 includes a control strategy for dealing with unbalanced situations among multiple converter modules. The controller 4 also includes a control strategy for optimizing harmonic performance of the power supply system. Embodiments of the control method implemented by the controller 4 will be introduced in the section of exemplary methods below.

In an example, the controller 4 is implemented in a distributed control system (not shown) including multiple controller nodes. For example, the distributed control system includes a controller node at the transformer, a controller node at the load, and a controller node at each converter module. In this example, the controller 4 can be integrated with the controller node at a converter module, and in commutation with other controller nodes of the distributed control system. The controller 4 can also be provided as in independent controller node and integrated with the converter modules to form an intelligent modular converter.

In another example, the controller 4 can be implemented in a centralized control system (not shown) including a high-level controller (e.g., a supervisor control-ler) and multiple low-level controllers in communication with the high-level controller. For example, the low-level controllers include a low-level controller at the transformer, a low-level controller at each converter and a low-level controller at the load. In this example, the controller 4 can be provided in the high-level controller, and in commutation with the low-level controllers. The controller 4 can also be provided in one of the low-level controllers, and in commutation with the high-level controller.

The controller 4 can be implemented by means of hardware or software or a combination of hardware and software, including code stored in a non-transitory computer-readable medium such as a memory and implemented as instructions executed by a processor. Regarding the part implemented by means of hardware, it may be implemented in an application-specific integrated circuit (ASIC), a digital signal processor (DSP), a data signal processing device (DSPD), a programmable logic device (PLD), a field programmable gate array (FPGA), a processor, a controller, a microcontroller, a microprocessor, an electronic unit, or a combination thereof. The part implemented by software may include a microcode, a program code or code segments. The software may be stored in a machine-readable storage medium, such as a memory.

In an example, the controller 4 includes a memory and a processor. The instructions are stored in the memory. The instructions, when executed by the processor, cause the processor to execute the powering methods according to examples of the present disclosure.

One aspect of the present disclosure relates to a power supply system including the above-mentioned modular converter 3 and the above-mentioned controller 4. Another aspect of the present disclosure relates to a method for controlling the power supply to power a load. The method can be implemented by the above-mentioned controller 4. Yet another aspect of the present disclosure relates to a transformer. Next, embodiments of the modular converter, the method and the transformer are introduced.

### Example Modular Converters

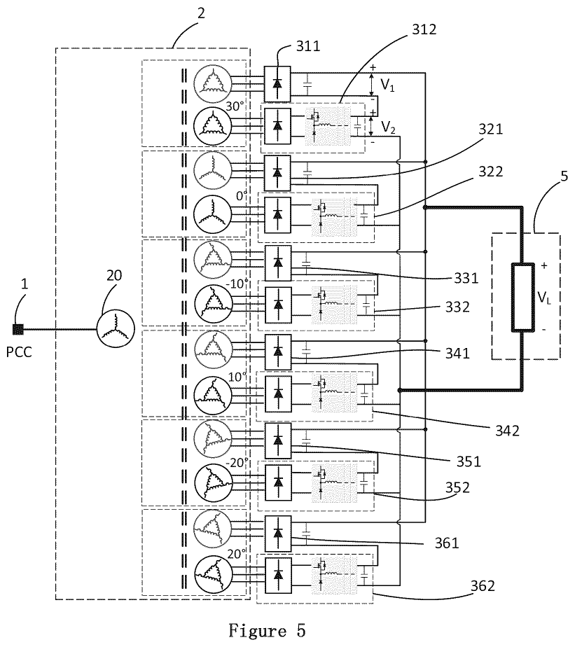

FIG. 5 shows a modular converter according to an example of the present disclosure. As shown in FIG. 5, the modular converter 3 includes six converter modules and is implemented as a 36-pulse rectifier, which cooperates with the phase shifting transformer 2 with six sets of secondary windings to power to the load 5. It is noted that the numerical values in FIG. 5 (for example, the number of converter modules, the number of pulses, and the phase angle) are exemplary and the present disclosure is not limited thereto.

Referring to FIG. 5, converter modules of the modular converter 3 are connected in parallel, and thus it can be called a parallel converter modular. For example, in such a modular converter, positive output terminals of the first converters 311~361 are connected together and connected to a positive terminal of the DC load 5, and negative output terminals of the second converters 312~362 are connected together and connected to a negative terminal of DC load 5.

Based on such a parallel topology, multiple converter modules can be func-tioned as current shunts, so the current flowing through each converter module is much smaller than the total current supplied to the load. Moreover, for each converter module, the partial power processing converter (i.e., the above-mentioned second converter) only processes a small fraction of the total power. In this way, the rated voltage, current and power of power electronic devices of the second converter can be much lower than that implemented with a full power processing converter. Therefore, device cost and size of such a modular converter can be greatly reduced.

For clarity, taking the load 5 is an electrolyzer as an example, above-mentioned principle and advantage are introduced.

In an example, the operating state of the electrolyzer changes from a light-load state to a full-load state, and the range of a variation in the power supplied to the electrolyzer is 30%. In this case, the first converters together would provide 70% of the total power to the load, and the second converters together would process 30% of the total power. There are six second converters, and thus each second converter would process only 5% of the total power, i.e., one sixth of 30%.

Such a parallel modular converter is suitable for powering the electrolyzer, because the electrolyzer has the following characteristics: the hydrogen production rate is positively correlated with the supplied current, and the supplied current is positively correlated with the supplied voltage. When the electrolyzer is operating at a full-load state, it corresponds to a high current and a high voltage. When the electrolyzer is operating at a light-load state, it corresponds to a low current and a low voltage. The parallel modular converter can be controlled by the controller 4 to adjust the current and voltage provided to the electrolyzer. Thus, the parallel modular converter can be used to adapt various needs of the powering of the electrolyzer.

Such a parallel modular converter is also suitable for powering a power battery of an electric vehicle, because the charging mode of the power battery includes a constant voltage charging mode and a constant current charging mode. Which charging mode to use depends on the state of charge (SOC) of the power battery. For example, in the case that the SOC of the power battery is in the range of 0~95%, the constant current charging mode is used. In the case that the SOC of the power battery is in the range of 95%~98%, the constant voltage charging mode is used. The parallel modular converter can be controlled by the controller 4 to adjust the current and voltage provided to the power battery. Thus, the parallel modular converter can be used to adapt various needs of the powering of the power battery.

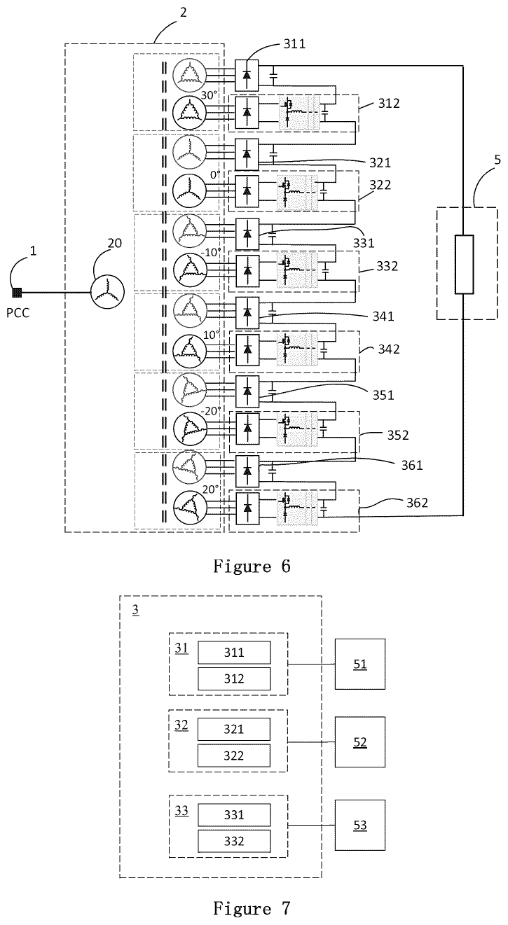

FIG. 6 shows a modular converter according to another example of the present disclosure.

As shown in FIG. 6, the modular converter 3 includes six converter modules and is implemented as a 36-pulse rectifier, which cooperates with the phase shifting transformer 2 with six sets of secondary windings to power the load 5. It is noted that the numerical values in FIG. 5 (for example, the number of converter modules, the number of pulses, and the phase angle) are exemplary and the present disclosure is not limited thereto. Referring to FIG. 6, converter modules of the modular converter 3 are connected in serious, and thus it can be called serious converter modules. For example, in such a serious topology, a negative output terminal of the second converter 312 of the first converter module is connected to a positive output terminal of the first converter 321 of the second converter module, and a negative output terminal of the second converter 322 of the second converter module is connected to a positive output terminal of the second converter 321 of the third converter module, and so on. Based on such a series topology, a high voltage can be supplied to the load 5 The modular converter 3 with such a series topology is suitable for providing a high voltage to power a high-voltage rectification system. For example, the high voltage is supplied to a front end of the high-voltage rectification system of a hybrid or electric truck. In addition, according to an example of the present disclosure, outputs of those converter modules are isolated from each other because the AC-DC conversion has been done at the front end. In this way, the output of each converter module can be respectively connected to one load and transfer power to said one load. Alternatively, the outputs of multiple converter modules can be connected in series or in parallel to one load and transfer power to said one load.

FIGS. 7 and 8 show examples of using the modular converter 3 to power multiple loads.

Referring to FIG. 7, in an example, the modular converter includes three converter modules 31-33, and each converter module is respectively connected to one of three loads 51-53. In this example, the converter module 31 is connected to the load 51 and powers the load 51, the converter module 32 is connected to the load 52 and powers the load 52, and the converter module 33 is connected to the load 53 and powers the load 53. The application scenario of this example is, for example, that each converter module is connected to a power battery of an electric vehicle, so that multiple electric vehicles can be charged simultaneously.

Referring to FIG. 8, the modular converter 3 includes eight converter modules 31-38, wherein four converter modules 31-34 are connected in series or in parallel and are connected to the load 51 to power the load 51, and the other four converter modules 35-38 are connected in series or in parallel and are connect to the load 52 to power the load 52. The application scenario of this example is, for example, that the modular converter simultaneously powers multiple electrolyzers with different hydrogen production rate.

### Example Methods

Further to example systems described above, example methods are now described. Such methods can be performed by the controller 4 described above. It should be understood that the operations involved in the following methods need not be performed in the precise order described. Rather, various operations may be performed in a different order or simultaneously, and operations may be added or omitted.

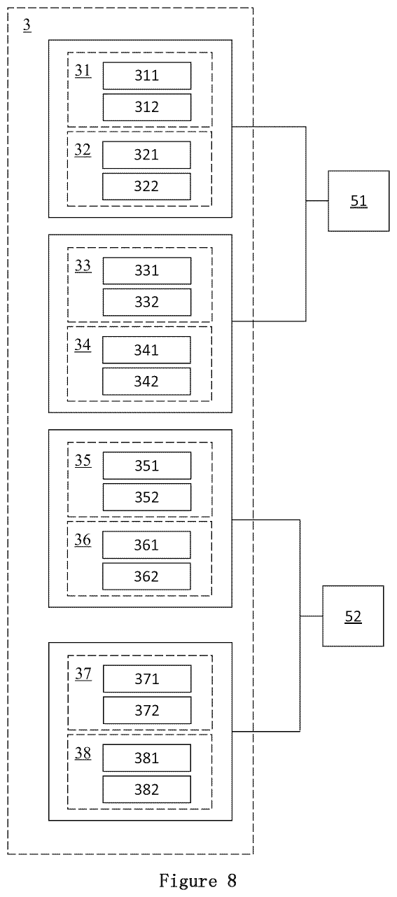

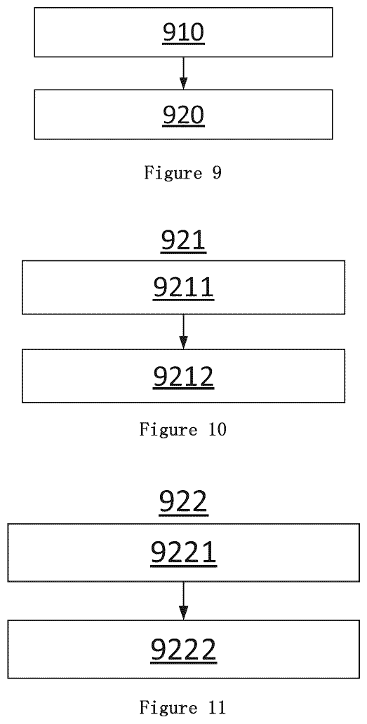

FIG. 9 is a flowchart of a method 900 for controlling a power supply system to power a DC load according to an embodiment of the present disclosure. According to the method 900, the controller 4 controls at least one converter module to adjust the DC voltage supplied to the load 5.

Referring to FIG. 9, at block 910, the controller 4 receives feedback information regarding at least one of the transformer 2, the modular converter 3 and the load 5.

In an example, the feedback information can include the information on an operating state of the load, a current, a voltage and power supplied to the load. The feedback information can also include harmonic information.

In an example, the feedback information can include the information on measurements measured at the primary side and/or the secondary side of the transformer. For example, the measurements include a measured current and a measured voltage. The feedback information can also include the information on states of the first converter and the second converter of each converter module. For example, the states include the voltage or frequency changed by each converter module. The feedback information can also include the information on measurements measured at the load, such as a load current and a load voltage.

In an example, the load is an electrolyzer and the feedback information includes one or more of: a hydrogen production rate of the electrolyzer, an electrolyzer current (i.e., a current flowing through the electrolyzer), an electrolyzer voltage (i.e., a voltage across the electrolyzer), an operating efficiency of the electrolyzer, a state of health (SOH) of the electrolyzer, an aging indicator indicating an aging degree of the electrolyzer and an operating state of the electrolyzer (e.g., a light-load state, a full-load state, and an over-load state).

At block 920, the controller 4 controls at least one second converter to adjust the DC voltage supplied to the load based on the feedback information.

Such control realizes an adjustable power supply to the load 5. Thus, the power supply to the load 5 can adapt to various working conditions of the load. Such control can also help to take care of an imbalance condition between multiple converter modules. Such control can also help to reduce the total harmonic distortion (THD). Examples of block 920 are described below.

FIG. 10 shows an example (block 921) of block 920. In this example, the load 5 is an electrolyzer and the control is implemented based on an operating state of the electrolyzer.

Referring to FIG. 10, at block 9211, the controller 4 obtains a target operating state of the electrolyzer and an actual operating state of the electrolyzer based on the feedback information.

The target operating state of the electrolyzer can be determined by a supervisor controller through coordinated control based on a user demand or a grid demand (for example, an active power and reactive power demand). The information on the target operating state can be included in the feedback information to be sent to the controller 4. The actual operating state of the electrolyzer can be determined based on measurements measured by a sensor coupled with the electrolyzer. The information on the actual operating state can be included in the feedback information to be sent to the controller 4.

At block 9212, the controller 4 controls the second converter of each converter module to adjust the second DC voltage V₂, so that the power supply to the electrolyzer is controlled and that the operating state of the electrolyzer is controlled. For example, in the case that the actual operating state of the electrolyzer is consistent with the target operating state of the electrolyzer, the control of the controller 4 remains unchanged. In the case that the actual operating state of the electrolyzer is inconsistent with the target operating state of the electrolyzer, the controller 4 controls one or more of the converter modules such that the actual operating state of the electrolyzer becomes consistent with the target operating state of the electrolyzer. Examples of block 9212 are described below.

In an example, if the target operating state of the electrolyzer is a full-load state and the actual operating state of the electrolyzer is also a full-load state, the controller 4 keeps the current control unchanged.

In another example, if the target operating state of the electrolyzer is a full-load state and the actual operating state of the electrolyzer is operating with the lowest load, the controller 4 controls the second converter of each converter module to adjust the second DC voltage V₂, so that the actual operating state of the electrolyzer changes from the lowest-load-state to the full-load state. For example, if the converter system is implemented with the step-down topology, the second DC voltage is adjusted to the minimum value within its adjustable range. If the converter system is implemented with the step-up topology, the second DC voltage is adjusted to the maximum value within its adjustable range.

In yet another example, if the target operating state of the electrolyzer is a light-load state and the actual operating state of the electrolyzer is also a light-load state, the controller 4 keeps the current control unchanged.

In yet another example, if the target operating state of the electrolyzer is operating with the lowest load and the actual operating state of the electrolyzer is a full-load state, the controller 4 controls the second converter of each converter module to adjust the second DC voltage V₂, so that the actual operating state of the electrolyzer changes from the full-load state to the lowest-load-state. For example, if the converter system is implemented with the step-down topology, the second DC voltage is adjusted to the maximum value within its adjustable range. If the converter system is implemented with the step-up topology, the second DC voltage is adjusted to the minimum value within its adjustable range.

In addition, in the case that the target operating state of the electrolyzer is an overload state, and the second DC voltage V₂ has been adjusted to the maximum value or the minimum value within the adjustable range, the controller 4 can generate a control signal for changing a tap position of the tap changer coupled to the primary side of the transformer so that both the first DC voltage V₁ and the second DC voltage V2 are controlled and that the actual operating state of the electrolyzer can be adjusted to the overload state.

FIG. 11 illustrates another example (block 922) of block 920. In this example, the load 5 is an electrolyzer and the controller 4 performs the control according to the SOH (state of health) of the electrolyzer, so that both the operating efficiency and the hydrogen production rate of the electrolyzer can be optimized.

Referring to FIG. 11, at block 9221, the controller 4 determines whether the SOH of the electrolyzer is degraded based on the feedback information. For example, the controller 4 compares the measured SOH and a history SOH previously stored in the controller 4 to determine whether the SOH of the electrolyzer is degraded.

At block 9222, in the case that the SOH of the electrolyzer is determined to be degraded, the controller 4 controls the second converter of each converter module to adjust the second DC voltage V₂, so that the voltage supplied to the electrolyzer can be controlled.

For example, if the SOH of the electrolyzer is degraded, the resistance of the electrolyzer would increase. In this case, the controller 4 controls the second converter of each converter module to adjust the second DC voltage V₂, so that the voltage supplied to the electrolyzer is increased to ensure that the hydrogen production rate reaches the target hydrogen production rate. Thus, the target hydrogen production rate would not be unable to be reached due to the degradation of the SOH of the electrolyzer.

In addition, in this example, both the first DC voltage V₁ and the second DC voltage V₂ can be controlled by changing the tap position of the tap changer coupled to the primary side of the transformer, so that the target hydrogen production rate can be reached.

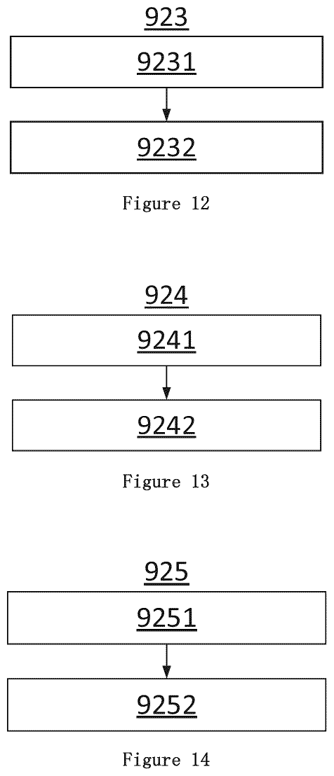

FIG. 12 illustrates yet another example (block 923) of block 920. In this example, the controller 4 controls one or more converter modules so that the powering mode is suitable for powering the load, for example, a constant-voltage mode or a constant-current mode.

At block 9231, the controller 4 determines whether to power the load in a constant-voltage mode or a constant-current mode based on the feedback information.

For example, in the case that the load is a power battery of an electric vehicle, the controller 4 determines to power the load in the constant-voltage mode or the constant-current mode based on the SOC of the power battery. For example, a rule table including rules of determining a suitable mode for powering the load is pre-stored in the controller 4. The rules can include powering a power battery in the constant-current mode when the SOC of the power battery is in the range of 0-95% and powering the power battery in the constant-voltage mode when the SOC of the power battery is in the range of 95%-98%.

At block 9232, the controller 4 controls the second converter of at least one converter module so that the load is powered in the determined mode.

For example, if it is determined to power the load in the constant-voltage mode, the controller 4 controls the second converter of at least one converter module to provide a constant voltage to the load. If it is determined to power the load in the constant-current mode, the controller 4 calculates an adjustment amount of the second DC voltage to ensure the current provided to the load is constant and controls the second converter of at least one converter module to adjust the second voltage by the adjustment amount.

FIG. 13 illustrates yet another example (block 924) of block 920. In this example, in the case that a short-circuit fault occurs, the load can be quickly disconnected from the power supply system.

Referring to FIG. 13, at block 9241, the controller 4 determines whether a short-circuit fault occurs based on the feedback information. For example, the controller 4 determines whether a short-circuit fault occurs in the power supply system or in load by comparing a measured current to a current threshold.

At block 9242, if it is determined the short-current fault occurs, the controller 4 controls power electronic switches of the second converter to cut off the supply current for powering the load. In this way, the supply current can be cut off by controlling the controllable switches of the second converter. Such cutting off is very fast, thereby realizing a quick response to the short-circuit fault. In this case, the transformer can be disconnected from the converter modules by operating switches connected between the transformer and the converter modules in the case of no current flowing between them, and then the load can be disconnected from the power supply system.

FIG. 14 shows yet another example (block 925) of block 920. In this example, if an imbalance arises among multiple converter modules, the controller 4 can control the multiple converter modules to return to a balance state. Such control is ad-vantageous for a scenario where a modular converter including multiple converter modules is used, since the harmonic performance will be good when the multiple converter modules are in the balance state. Moreover, all of the multiple converter modules would have almost the same lifetime when they are in the balance state.

Referring to FIG. 14, at block 9251, the controller 4 determines whether an imbalance among multiple converter modules arises based on the feedback information.

In examples of the present disclosure, “balance” should be understood as the power, current and voltage transferred through each converter module are in a stable state, that is, the power, current and voltage transferred by each converter module have invariance in time. For example, as to the above-mentioned parallel converter modules, the main factor is the current converted by individual converter modules. If the current transferred through each converter module is equal, the multiple converter modules are seen as in a balance state. As to the above-mentioned serious converter modules, the main factor is the voltage converted by individual converter modules. If the voltage transferred through each converter module is equal, the multiple converter modules are seen as in a balance state.

In examples of the present disclosure, “imbalance” should be understood as the power, current or voltage converted by at least one converter module of the multiple converter modules is in an unstable state. The unstable state includes, for example, ir-regular fluctuations in current, voltage or power. The unstable state also includes, for example, that the power, current or voltage transferred through at least one converter module is different than that transferred through other converter modules. The unstable state also includes, for example, that the power, current or voltage converted by the at least one converter module deviates from a predetermined conversion ratio.

It is understood that the above definitions of “balance” and “imbalance” can be used as rules for determining whether an imbalance arises among multiple converter At block 9252, in the case that it is determined an imbalance arises among multiple converter modules, the controller 4 controls the second converter of at least one converter module to remove the imbalance.

For clarity, an example of the control for the above-mentioned imbalance situation is described with reference to FIG. 5. As shown in FIG. 5, six converter modules are connected in parallel. When the six converter modules are in a balance state, the powering current provided to the load through each converter module is equal to each other. Assume that such an imbalance arises: the powering current provided to the load through the first converter module is not equal to the current provided to the load through any of the other five converter modules. In this case, the controller 4 calculates a difference between the current through the first converter module and the current through any of the other five converter modules. Next, the controller 4 controls the second converter of the first converter module with the aim of compensating for the calculated difference, so that the current through the first converter module will be equal to the current through any of the other five converter modules. Thus, these converter modules are back to the balance state.

Examples of the present disclosure also provides a machine-readable storage medium storing executable instructions that, when executed, cause a machine to perform the methods described above.

### Example Transformers

The present disclosure provides a transformer. According to an example of the present disclosure, the transformer is disposed in a power supply system for powering a load. Such a transformer is provided based on the following factors: various cases for harmonics of the power supply system, a power supply demand of an end load, the rated power and rated current of each converter of the power supply system. In this way, the transformer can be “perfect” in the power supply system to transfer power to the load. Examples of the transformer are described below.

First, a minimum value of the pulse number n of the transformer is determined based on the worst-case for harmonics, i.e., a situation where the power supply system has the worst harmonic performance. That is to say, the minimum value of the pulse number of the transformer is determined based on this minimum-load-rate situation. This is because in various operating states of the power supply system, the worst-case for harmonics should be less than a predetermined level (e.g., the predetermined level is predefined based on the harmonic requirement of the grid coupled with the AC source or based on the harmonic requirement of the PCC on the grid side). The worst-case for harmonics can be different in different application scenarios. Examples of the worst-case for harmonics are introduced below.

In an example, the worst-case for harmonics of the power supply system occurs at the minimum load rate. For example, the total harmonic distortion of the power supply system when the power supply system is operating at the minimum load rate should meet the harmonic requirement of the grid coupled to the AC source (e.g., the harmonic requirement of the PCC point).

It is noted that the load rate refers to the ratio of the operating power of the load to the rated power of the load. For an electrolyzer, rated power refers to the product of its maximum current and maximum voltage. For example, if the operating power of the load is equal to the rated power, the load rate is 100%. If the operating power of the load is 30% of the rated power, the load rate is 30%. If the operating power of the load is greater than the rated power, the load rate is greater than 100%. In an example, the load rate can be used to define the light-load state (for example, the load rate is less than 50%), the full-load state (for example, the load rate is 100%) and the overload-state (for example, the load rate is greater than 100%).

For clarity, taking the load 5 is an electrolyzer as an example, the above-mentioned determination of the minimum value of the pulse number is introduced. It is noted that the numerical values used in the following description are illustrative. For example, a 5MW (1000 V, 5000 A) electrolyzer is operating at a minimum load rate of 20% (i.e., 1 MW), and the harmonic requirement is that the total harmonic distortion is below 3%. Based on the minimum load rate and the harmonic requirement, the minimum value of the pulse number is determined to be a 36-pulse. That is to say, a 36-pulse transformer is provided to meet the harmonic requirement.

In another example, the transformer includes two or more parts and the worst-case for harmonics of the power supply system occurs when only one part of the two or more parts is operating. The minimum value of the pulse number of the transformer is determined based on the only-one-part-operating situation.

For clarity, this example is further introduced with reference to FIG. 16. The transformer shown in FIG. 16 includes two parts. Each of the two parts is implemented as a 24-pulse configuration and the two parts together form a 48-pulse configuration. When only one part is operating, i.e., the transformer is operating with a 24-pulse configuration, the total harmonic distortion caused by the 24-pulse configuration should be less than a predetermined level (e.g., the predetermined level is predefined based on the harmonic requirement of the PCC point). Similarly, in another example, the transformer is implemented as a 24-pulse configuration including two 12-pulse con-figurations, and total harmonic distortion caused by a 12-pulse configuration (i.e., the situation where only one part is operating) exceeds the predetermined level, in this case, the transformer can be changed to a 48-pulse configuration including two 24-pulse con-figurations. In this case, if only one part is operating, the transformer will operate with a 24-pulse configuration and can meet the harmonic requirement. In this case, a 48-pulse transformer is provided.

In yet another example, the minimum value of the pulse number of the transformer is determined based on a combination of the above-mentioned situations. For example, the transformer includes two parts and the worst-case for harmonics of the power supply system occurs when only one part is operating at the minimum load rate. In this case, the minimum value of the pulse number of the transformer is determined based on such a combined situation, and a transformer which is able to produce an output with the determined pulse number when coupled with converters is provided In addition, in an example, the minimum value of the pulse number is determined further based on a redundancy value. In this example, the pulse number of the transformer is equal to a sum of the minimum value determined based on the worst-case for harmonics and the redundancy value. This enables the transformer capable of operating well in fault situations or unstable situations. This can also reduce the total harmonic distortion of the power supply system below a predetermined level.

The redundancy value can be calculated based on experimental results and/or a mathematical model. For example, an optimization model for optimizing harmonic performance in different application scenarios is created previously and stored in the controller. The redundancy value can be obtained by using this optimization model.

Next, the number N of sets of secondary windings is determined based on the minimum value of the pulse number n. In an example, the number N of sets of secondary windings can be calculated according to the following formula: n=6*N, where n is the minimum value of the pulse number, and N is the number of sets of secondary windings. In an example, the number N is a positive integer and greater than or euqal to 2.

In an example, the number N of sets of secondary windings is further determined based on the rated power and rated current of each converter module, a power supply demand of the load, and modular design requirements of the modular converter.

In an example, the number N of sets of secondary windings can be increased. For example, if the number of sets of secondary windings is determined to be six, this number can be increased to twelve. That is to say, six sets of secondary windings are expanded to twelve sets. In this way, the voltage, current and power that each converter module needs to withstand can be reduced, so that low-cost and more power electronic devices can be selected.

Next, phase shifting provided by the windings is introduced. For example, when a winding adopts the delta connection, the phase shift is provided as follows: the winding includes a basic winding and a phase shifting winding, and the basic winding and the phase shifting winding have different turns. A composite voltage is obtained after the basic winding and the phase shifting winding are connected, and the phase angle of the winding voltage is different under different connections. It is noted that the ZAGZIG can also achieve phase shifting based on the above-mentioned principle through a Z connection.

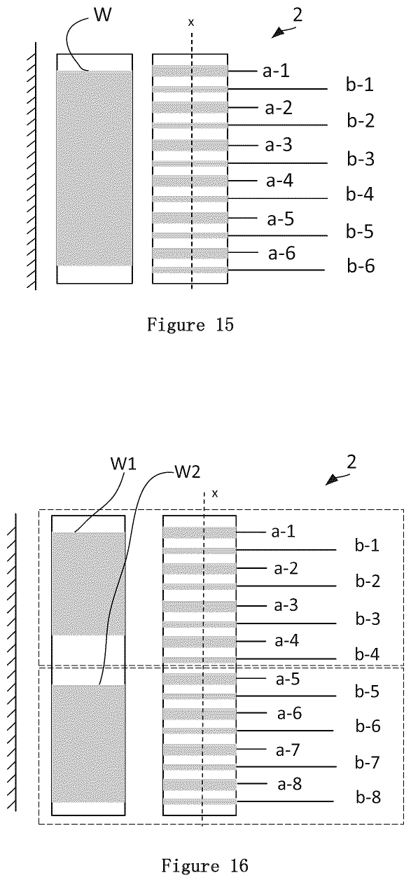

Some examples of the configuration of primary and secondary windings of the transformer are described with reference to FIGS. 15-18.

FIG. 15 shows an example of the transformer 2. As shown in FIG. 15, the transformer 2 has one primary winding W. On the secondary side, the high-power secondary winding and the low-power secondary winding are arranged alternatively along an axial direction (as shown by the dotted line in FIG. 15) of the secondary windings. For example, the secondary windings are arranged along the axial direction in the following sequence: high-power secondary winding a-1->low-power secondary winding b-1->high-power secondary winding a-2->low-power secondary winding b-2 . . . high-power secondary winding a-6->low-power secondary winding b-6. In the axial direction, the height of the primary winding W corresponds to the overall height of the secondary windings. For example, half the height of the primary winding W is aligned with half the overall height of the secondary windings.

FIG. 16 shows another example of the transformer 2. As shown in FIG. 16, the transformer 2 includes two primary windings W1 and W2. Each of the two primary windings corresponds to half of the transformer capacity. That is to say, each of the two primary windings can transfer power equal to half of the transformer capacity. The secondary windings are arranged in two sections. Each section corresponds to one primary winding and receives power transferred from said one primary winding. For example, one of the two sections is aligned in the axial height with one primary winding W1 and the other of the two sections is aligned in the axial height with the other primary winding W2. In each of the two sections, the high-power secondary winding and the low-power secondary winding are arranged alternatively along an axial direction (as shown by the dotted line in FIG. 16) of the secondary windings. For example, one section of secondary windings includes high-power secondary windings a1~a4 and low-power secondary windings b1~b4, and these secondary windings are arranged along the axial direction in the following sequence: high-power secondary winding a-1->low-power secondary winding b-1->high-power secondary winding a-2->low-power secondary winding b-2 . . . high-power secondary winding a-4->low-power secondary winding b-4. Another section of secondary windings includes high-power secondary windings a5~a8 and low-power secondary windings b5~b8, and these secondary windings are arranged along the axial direction in the following sequence: high-power secondary winding a-5->low-power secondary winding b-5->high-power secondary winding a-6->low-power secondary winding b-6 . . . high-power secondary winding a-8->low-power secondary winding b-8.

According to yet another example (not shown) of the transformer 2, the transformer 2 includes three primary windings. Each of the three primary windings corresponds to one third of the transformer capacity. The secondary windings are arranged in three sections. Each section corresponds to one primary winding and receives power transferred from said one primary winding. For example, each of the three sections is aligned in the axial height with one primary windings. In each of the three sections, the high-power secondary winding and the low-power secondary winding are arranged alternatively along an axial direction of the secondary windings.

The examples of the transformer including two or more primary windings are helpful for the ampere-turn balance of transformer windings in the event of a fault (e.g., an open-circuit fault) occurring in at least one converter coupled to the transformer. For example, when an open-circuit fault occurs in at least one converter, the ampere-turn balance of transformer windings can exceed a predetermined level without being too bad. In other words, when the primary side of the transformer includes two or more primary windings, such a transformer has a better ampere-turn balance.

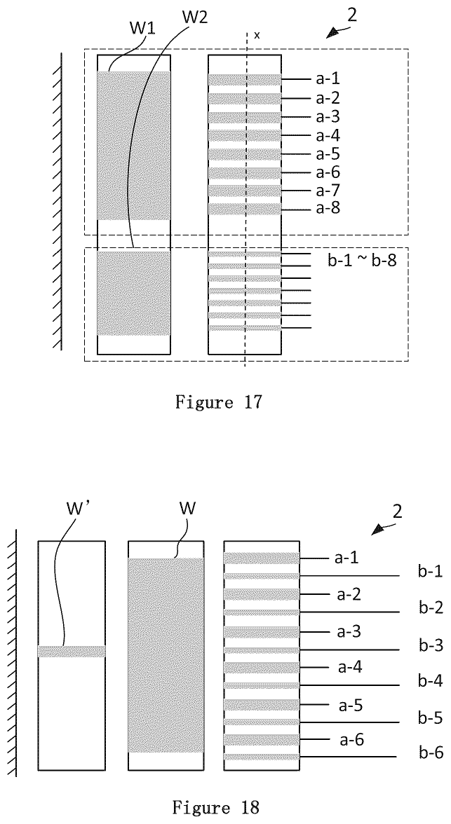

FIG. 17 shows yet another example of the transformer 2. As shown in FIG. 17, the transformer 2 includes two primary windings W1 and W2. These two primary windings correspond to different ratios of the transformer capacity. For example, one of the two primary windings is capable of transferring more power than the other. The secondary windings are arranged in two sections. Each section corresponds to one of the two primary windings. One of the two sections includes high-power secondary windings. For example, high-power secondary windings al~a8 are included in said one section and arranged along the axial direction in the following sequence: high-power secondary winding a-1->high-power secondary winding a-2 . . . high-power secondary winding a-8. The other of the two sections includes low-power secondary windings. For example, low-power secondary windings b1~b8 are included in said the other section and arranged along the axial direction in the following sequence: low-power secondary winding b-1->low-power secondary winding b-2 . . . low-power secondary winding b-8.

In an example, the above-mentioned different ratios are determined based on a ratio between the power transferred through the first converter and the power transferred through the second converter in a converter module coupled to the transformer. For example, in the converter module 31, the ratio between the power transferred through the first converter 311 and the power transferred through the second converter 212 is 8:2. In this case, one of the two primary windings corresponds to 80% of the transformer capacity, and the other of the two primary windings corresponds to 20% of the transformer capacity.

FIG. 18 shows yet another example of the transformer 2. In this example, the transformer 2 further includes an additional winding W′ for powering accessories (e.g., a cooling device, a heating device and a pump) of the power supply system.

In addition, in an example, the transformer 2 can further include a tap changer (not shown). The tap changer includes multiple switchable tap positions. The change of the tap position can be realized through the control of the controller, or by changing the tap position manually, so as to transfer power of different voltage levels from the primary side to the secondary side. In this way, the flexibility of powering the load can be further increased, so as to meet customized demands for powering the load.

According to an example of the present disclosure, a method for mounting the transformer 2 to a power supply system for powering the load 5 is provided. The method comprising the steps of coupling one or more primary windings of the transformer 2 to the AC source 1, and coupling at least two sets of secondary windings of the transformer 2 to the at least two converter modules. A high-power and a low-power secondary winding of each set of secondary windings are configured to transfer high power and low power to the load 5 respectively. The high-power secondary winding and the low-power secondary winding of each set of secondary windings have the same phase angle. A secondary winding of one of the at least two set of secondary windings has a different phase angle relative to a secondary winding of the other of the at least two sets of secondary windings.

It is noted that the controller can be implemented by means of hardware or software or a combination of hardware and software, including code stored in a non-transitory computer-readable medium such as a memory and implemented as instructions executed by a processor. Regarding the part implemented by means of hardware, it may be implemented in an application-specific integrated circuit (ASIC), a digital signal processor (DSP), a data signal processing device (DSPD), a programmable logic device (PLD), a field programmable gate array (FPGA), a processor, a controller, a microcontroller, a microprocessor, an electronic unit, or a combination thereof. The part implemented by software may include a microcode, a program code or code segments. The software may be stored in a machine-readable storage medium, such as a memory.

It is noted that software should be considered broadly to represent instructions, instruction sets, code, code segments, program code, programs, subroutines, software modules, applications, software applications, software packages, routines, subroutines, objects, running threads, processes, functions, and the like. Software can re-side on computer readable medium. Computer readable medium may include, for example, a memory, which may be, for example, a magnetic storage device (e.g., a hard disk, a floppy disk, a magnetic strip), an optical disk, a smart card, a flash memory device, a random access memory (RAM), a read only memory (ROM), a programmable ROM (PROM), an erasable PROM (EPROM), an electrically erasable PROM (EEPROM), a register, or a removable disk. Although a memory is shown as being separate from the processor in various aspects presented in this disclosure, a memory may also be internal to the processor (e.g., a cache or a register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalent transformations to the elements of the various aspects of the present disclosure, which are known or to be apparent to those skilled in the art, are intended to be covered by the claims.

1. A transformer comprising:
one or more primary windings configured to couple with an AC source; and
at least two sets of secondary windings, each set of secondary windings comprising a high-power secondary winding configured to transfer high power to a load and a low-power secondary winding configured to transfer low power to the load, wherein
the high-power secondary winding and the low-power secondary winding of each set are configured to produce no difference in phase angle with respect to each other, and
the secondary windings in one set of the at least two sets and the secondary windings in the other set of the at least two sets are configured to produce a difference in phase angle with respect to each other.

2. The transformer of claim 1, wherein the transformer is configured to couple with at least two converter modules to produce n-pulse power, and wherein the minimum value of the number n is provided based on a situation where a power supply system in which the transformer is disposed has the worst-case for harmonics.

3. The transformer of claim 2, wherein the minimum value of the number n is provided further based on a redundancy value for reducing the total harmonic distortion of the power supply system below a pre-determined level.

4. The transformer of claim 2, wherein the number of sets of secondary windings is provided based on the minimum value of the number n.

5. The transformer of claim 4, wherein the number of sets of secondary windings is provided further based on the rated current and rated power of each of the at least two converter modules.

6. The transformer of claim 1, wherein each set of secondary windings is configured to couple with at least one converter module having two converters one of the two converters being a partial power processing converter; and wherein the low-power secondary winding is configured to couple with the partial power processing converter for transferring the low power.

7. The transformer of claim 1, wherein the transformer comprises one primary winding; and wherein the high-power secondary winding and the low-power secondary winding are arranged alternately in an axial direction of the secondary windings

8. The transformer of claim 1, wherein the transformer comprises two or more primary windings so that an ampere-turn balance level of transformer windings exceeds a pre-determined level in the case that an open-circuit fault occurs in at least one converter coupled to the transformer .

9. The transformer of claim 1, wherein the transformer comprises two primary windings each of which corresponds to half of the transformer capacity; and wherein secondary windings of the transformer are arranged in two sections each of which corresponds to one of the two primary windings , and in each section, the high-power secondary winding and the low-power secondary winding are arranged alternately in an axial direction of the secondary windings

10. The transformer of claim 1, wherein the transformer comprises two primary windings corresponding to different ratios of the transformer capacity.

11. The transformer of claim 10, wherein secondary windings of the transformer are arranged in two sections each of which corresponds to one of the two primary windings; and wherein one section of the two sections comprises high-power secondary windings and the other section of the two sections comprises low-power secondary windings.

12. The transformer of claim 1, wherein the transformer comprises three primary windings each of which corresponds to one third of the transformer capacity; and wherein the secondary windings are arranged in three sections each of which corresponds to one of the three primary windings, and in each section, the high-power secondary winding and the low-power secondary winding are arranged alternately in an axial direction of the secondary windings.

13. The transformer of claim 1, the transformer further comprising an additional winding for transferring power to accessories of a power supply system in which the transformer is disposed.

14. The transformer of claim 1, the transformer further comprising a tap changer having multiple tap positions, wherein the position of the tap changer is switched under control of a control signal or manually.

15. A method for mounting a transformer as set forth in claim 1, to a power supply system for powering a load, the power supply system comprising an AC source and at least two converter modules, the method comprising:
coupling one or more primary windings of the transformer to the AC source; and
coupling at least two sets of secondary windings of the transformer to the at least two converter modules, a high-power and a low-power secondary winding of each set being configured to transfer high power and low power to the load respectively; wherein
the high-power secondary winding and the low-power secondary winding of each set are configured to produce no difference in phase angle with respect to each other, and
the secondary windings of one set of the at least two sets and the secondary windings of the other set of the at least two sets are configured to produce a difference in phase angle with respect to each other.

16. The transformer of claim 1, wherein the high-power secondary windings and the low-power secondary winding are arranged alternatively along an axial direction.

17. The method of claim 15, wherein the high-power secondary windings and the low-power secondary winding are arranged alternatively along an axial direction.
